(19) United States
(12) Patent Application Publication
(10) Pub. No.: US 2007/0029196 A1
(43) Pub. Date: Feb. 8, 2007

(54) Reference electrode and detector using the same for detecting acidity or basicity of oil

(75) Inventors: Yasuo Ishihara, Kariya-city (JP); Kazuyuki Horie, Nagoya-city (JP); Tetsuo Hariu, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/493,537

(22) Filed: Jul. 27, 2006

(30) Foreign Application Priority Data
Aug. 5, 2005 (JP) 2005-228652

(51) Int. Cl. G01N 27/26

(52) U.S. Cl. 204/416

(57) ABSTRACT

A reference electrode is used for detecting acidity or basicity of an oil with a sensitive electrode changed in response to the acidity or basicity of the oil. The reference electrode and the sensitive electrode are used as a pair of electrodes for detecting a difference between an electric potential of the sensitive electrode and an electric potential of the reference electrode. The reference electrode has a substantially constant output potential with respect to a pH which is changed according to the acidity or basicity of the oil. The reference electrode is constructed with an electrode substrate made of a metal, and a metal salt provided on the electrode substrate, such that the metal salt contains the metal and is hardly soluble in water.

### CROSS REFERENCE TO RELATED APPLICATION

This application is based on Japanese Patent Application No. 2005-228652 filed on Aug. 5, 2005, the contents of which are incorporated herein by reference in its entirety.

### BACKGROUND OF THE INVENTION

1. Field of the Invention

The present invention relates to a reference electrode for detecting acidity or basicity of oil, and a detector using the same.

2. Description of the Related Art

Various kinds of oils, such as fuel, hydraulic oil, quenching oil, and lubricating oil, have been industrially used. It is known that these oils show a gradual increase in their acidity due to oxidation by air, accumulation of a combustion product, during storage or use, and eventually undergo corrosion, or deterioration of their initial performances. Thus, quick and accurate detection of such oil deterioration is very important in maintenance of the oil.

A technique for quick and accurate detection of the oil deterioration has been proposed in which a pair of electrodes are constructed of a sensitive electrode having its electrical potential changed in response to the acidity or basicity of the oil, and a reference electrode differing from the sensitive electrode in an inclination degree representing the potential change. Furthermore, the pair of electrodes are immersed in the oil thereby to measure an increase in acid concentration in oil (decrease in pH), as disclosed in JP-A-3-175350 (corresponding to U..S Pat. No. 5,146,169).

In the above-mentioned patent document, a single metal, such as zinc (Zn), adapted to keep the potential substantially constant regardless of the change in pH of the oil is selected as a material for the reference electrode. This technique involves detecting an electrical potential of the sensitive electrode caused according to the acidity or basicity of the oil by measurement of the difference in electric potential between the reference and sensitive electrodes, and determining the pH of the oil corresponding to the potential difference.

JP-A-2004-45279 discloses a technique using an organic conductive film which covers a surface of an electrode. In this technique, the film is adapted to contain the same kind of solution as a solution to be measured, and electrolytes. A temperature range capable of detecting the pH of the solution to be measured, namely, oil is in an ordinary temperature range (for example, −30 to 50° C.) from the viewpoint of properties of the organic film.

The reference electrode as disclosed in JP-A-3-175350 is adapted to have the constant potential with respect to the change in pH by selecting a single metal material, such as zinc (Zn), which is apt to be dissolved in the solution, and whose basis metal is likely to be exposed. Any single metal, however, intends to have its surface oxidized, and thus its surface contains the basis metal and oxides thereof, resulting in low stability.

When measuring a potential of a zinc (Zn) electrode in fact, as shown in FIG. 3, the potential characteristic of the zinc (Zn) electrode (reference character Δ in FIG. 3) often becomes nonlinear, which leads to poor reproducibility, and hence this measurement is of little practical use.

Furthermore, the reference electrode as disclosed in JP-A-2004-45279 is likely to be influenced by a change in composition of the solution to be measured. When this electrode disclosed is applied to a reference electrode in which the solution to be measured is a hydraulic oil that may be influenced by a heat load, such as an engine oil of an internal combustion engine, or by accumulation of combustion products, it is difficult to design and make a film construction. The pH measurement of the oil at high temperatures (for example, 80 to 150° C.) may lead to dissolving of the film. This may not provide a stable constant potential to the reference electrode with respect to the pH change of the oil to be measured.

### SUMMARY OF THE INVENTION

It is therefore an object of the invention to provide a reference electrode for detecting acidity or basicity of oil which can achieve a stable surface condition of the electrode so as to obtain a stable constant potential with respect to a change in pH of the oil.

In order to achieve the above-mentioned object, the inventors have devoted to studies by carrying out various experiments in a combination of a metallic salt and a metal which is a basis of the metallic salt, taking into consideration the following facts: (1) in considering the principle of output of a reference electrode, an electric potential of the electrode is output according to the concentration of anions eluted from the electrode into a solution; and (2) the anion, in particular, an inorganic anion is not very soluble in a non-aqueous solution, such as oil, but soluble in a small amount of water existing in the oil. As a result, the inventors have found out that an electrode made of the combination of a metal and a hardly soluble salt based on the metal can serve as a reference electrode whose potential is stably constant with respect to the change in pH.

That is, according to an aspect of the present invention, a reference electrode is for detecting acidity or basicity of an oil with a sensitive electrode changed in response to the acidity or basicity of the oil, and the reference electrode has a substantially constant output potential with respect to a pH which is changed according to the acidity or basicity of the oil. In addition, the reference electrode includes an electrode substrate made of a metal, and a metal salt provided on the electrode substrate such that the metal salt contains the metal and is hardly soluble in water.

Because the metal salt is hardly soluble in water, namely, is a hardly soluble salt, all anions are not insoluble, but hardly soluble, when a relatively small amount of water exists in the oil, the concentration of the anions in water can reach substantially saturation or dissolution equilibrium. Furthermore, the reference electrode has its metallic surface previously covered with the hardly soluble salt based on the metal. Unlike the metallic oxide, the hardly soluble salt is not generated in measuring steps, and its amount is not increased. On the other hand, elution of the anions from the hardly soluble salt seldom occurs because the anions are in a state of the saturation or dissolution equilibrium. This can stabilize the surface condition of the reference electrode. Accordingly, the surface condition of the reference electrode can be stabilized so as to obtain the stable constant potential with respect to the change in pH of the oil to be measured.

For example, the metallic salt can be made of any one of zinc phosphate [Zn₃(PO₄)₂], iron phosphate [FePO₄], palladium bromide [PdBr₂], silver chloride [AgCl], silver bromide [AgBr], silver iodide [AgI], copper iodide [CuI], and silver sulfide [AgS]. This can stabilize the surface condition of the reference electrode so as to provide the stable constant potential to the electrode with respect to the change in pH of the oil to be measured. These metallic salts can be made relatively easily by combining any one of the zinc phosphate [Zn₃(PO₄)₂], iron phosphate [FePO₄], palladium bromide [PdBr₂], silver chloride [AgCl], silver bromide [AgBr], silver iodide [AgI], silver sulfide [AgS], and copper iodide [CuI] with a corresponding one of the metal of zinc [Zn], iron [Fe], palladium [Pd], silver [Ag], and copper [Cu].

Also, the sensitive electrode constituting a pair of electrodes in combination with the above-mentioned reference electrode may be a metallic electrode with its surface covered with a metallic oxide. This can form a passive state on the surface of the sensitive electrode with the metallic oxide.

In general, when a metallic structure composed of a metallic salt and a metal serving as a basis of the salt is intended to be made in the form of a thin plate, the strength of the electrode structure may not be ensured sufficiently. However, when using a substrate part made of, for example, stainless material, a metallic structure can be made on the surface of the substrate as a film part having a thin plate-like or thin film-like shape, for example, by vapor deposition or the like. The entire substrate and metallic structure can improve the strength of the electrode.

Since the solution to be measured is a solution of lower water content, for example, oil, such as engine oil, the relatively gradual elution of anions from the metallic salt will readily lead to the saturation or dissolution equilibrium state of the concentration of ions in the water. Thus, the constant potential can be given to the reference electrode responsively in a reproducible manner with respect to the change in pH of the oil to be measured.

The working temperature range of the hydraulic oil used in an internal combustion engine is generally a range of relatively higher temperatures than the room temperature (for example, about 80 to 150° C.).

In addition, since the reference electrode is constructed of an inorganic individual member consisting of the metal and the metallic salt, the reference electrode has high reliability in heat resistance or the like, as compared with the known reference electrode including an organic matter, such as an organic film.

According to another aspect of the present invention, a detector for detecting acidity or basicity of an oil includes a reference electrode, and a sensitive electrode changed in response to the acidity or basicity of the oil. The reference electrode and the sensitive electrode are used as a pair of electrodes for detecting a difference between an electric potential of the sensitive electrode and an electric potential of the reference electrode. Furthermore, the reference electrode includes an electrode substrate made of a metal, and a metal salt provided on the electrode substrate such that the metal salt contains the metal and is hardly soluble in water. In addition, the reference electrode has a substantially constant output potential with respect to a pH which is changed according to the acidity or basicity of the oil. Accordingly, the detector can accurately detects the acidity or basicity of the oil by using the reference electrode.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram showing a structure of a pair of electrodes using a reference electrode for detecting acidity or basicity of oil according to a first embodiment of the invention;

FIG. 2 is a partial sectional view showing a structure of an oil deterioration detecting device to which the reference electrode for detecting acidity or basicity of oil of the first embodiment is applied;

FIG. 3 is a graph showing a potential characteristic of the reference electrode of the first embodiment, while showing a relationship between an electric potential of the reference electrode and a pH;

FIG. 4 is a schematic diagram showing a test device for measuring the potential characteristic of the reference electrode;

FIG. 5 is a schematic diagram for explaining the principle of output of the reference electrode for detecting acidity or basicity of oil according to the first embodiment, in which a solution to be measured is oil, and the reference electrode is based on the first embodiment;

FIG. 6 is a schematic diagram for explaining the output principle of potential of a known reference electrode as a comparison example, in which a solution to be measured is an aqueous solution, and the reference electrode is based on the first embodiment;

FIG. 7 is a schematic sectional view showing a reference electrode for detecting acidity or basicity of oil according to a second preferred embodiment of the invention;

FIG. 8 is a graph showing a potential characteristic of the reference electrode of the second embodiment, while showing a relationship between an electric potential of the reference electrode and a pH;

FIG. 9 is a graph showing a potential difference characteristic of a pair of electrodes using the reference electrode for detecting acidity or basicity of oil of the second embodiment, while showing a relationship between a pH and a difference in potential between the reference electrode and a sensitive electrode;

FIG. 10 is a schematic sectional view showing a reference electrode for detecting acidity or basicity of oil according to another embodiment;

FIG. 11 is a schematic sectional view showing a reference electrode for detecting acidity or basicity of oil according to a further another embodiment; and

FIG. 12 is a schematic diagram showing a structure of a pair of electrodes using a reference electrode of a comparison example for detecting acidity or basicity of oil.

### DETAILED DESCRIPTION OF THE PREFERRED EMBODIMENTS

(First Embodiment)

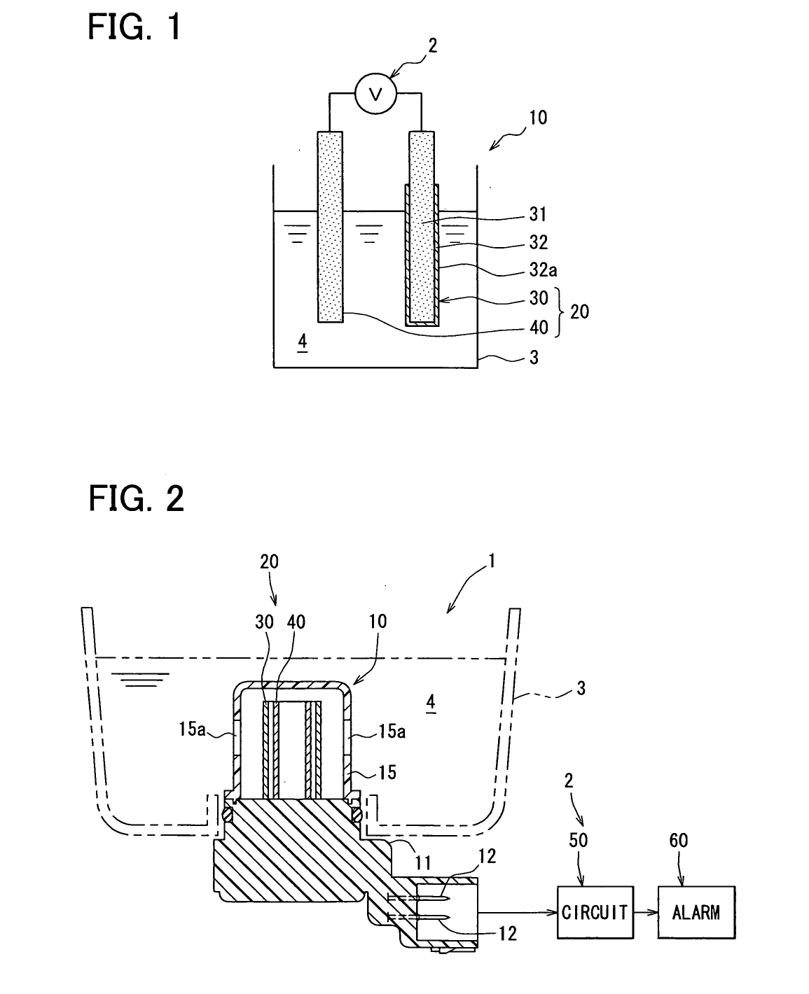

The first embodiment will be described with reference to FIGS. 1-6. FIG. 1 is a schematic diagram showing a structure of a pair of electrodes using a reference electrode for detecting acidity or basicity of oil according to the first embodiment, and FIG. 2 is a partial sectional view showing a structure of an oil deterioration detecting device 1 to which the reference electrode for detecting acidity or basicity of oil of the first embodiment is applied.

Referring to FIG. 2, an oil deterioration detecting device 1 is attached to, for example, an oil pan 3 of a vehicle, and detects a deterioration degree of oil 4 to be used for at least one of hydraulic control and lubrication. The oil deterioration detection device 1 includes an oil deterioration detector (hereinafter referred to as an oil deterioration sensor) 10, and a determination circuit 50 serving as control means for receiving an oil deterioration signal input from the oil deterioration sensor 10 and evaluating an oil quality based on the oil deterioration signal. The determination circuit 50 includes a measurement circuit (not shown) for measuring the oil deterioration signal, and an evaluation circuit (not shown) for evaluating the oil quality based on a measurement value provided by the measurement circuit. The oils for the hydraulic control and for the lubrication constitute hydraulic oil (hereinafter referred to as an engine oil) to be used in an internal combustion engine.

The determination circuit 50 may include alarm means 60 for giving an alarm to a passenger, such as a driver of the vehicle, for example, when the measurement value exceeds a threshold value in comparing the measurement value to the threshold one. This alarm means 60 may be any known alarm means, such as an alarm lamp or buzzer for notifying the passenger of the state by lighting up or by sounding an alarm. The alarm means 60 can be provided on a vehicle display, such as a meter not shown, or a display of a navigation device.

The alarm means 50 may be provided with known oil life estimation means. In some cases, the life of oil is intended to be estimated by associating the life with a property value regarding a driving time of the internal combustion engine, such as a traveling distance of the vehicle. A method for estimating a life of oil is well known which involves associating the traveling distance of the vehicle with a property of a difference in potential between a pair of electrodes for detecting acidity of basicity of oil, that is, a difference in potential between two electrode having different rates of changes in potential, thereby estimating the life of the oil.

The oil deterioration sensor 10, as shown in FIG. 2, includes two different electrodes, namely, a first electrode (hereinafter referred to as a reference electrode) 30, and a second electrode (hereinafter referred to as a sensitive electrode) 40. The reference electrode 30 and the sensitive electrode 40 are attached to an electrode holding member (supporting member) 11 made of an insulating resin with an adhesive or the like as shown in FIG. 2.

Although the reference electrode 30, the sensitive electrode 40, and the electrode holding member 11 are connected and fixed to one another with the adhesive or the like, the invention is not limited thereto. When the electrode holding member 11 is resin-molded, the reference electrode 30 and the sensitive electrode 40 may be insert-molded into the holding member. As shown in FIG. 2, terminals 12 that are electrically connected to the reference electrode 30 and the sensitive electrode 40, respectively, are embedded in the electrode holding member 11.

The reference electrode 30 and the sensitive electrode 40 are immersed in the oil 4 of the oil pan 3 (indicated by a dashed-two dotted line in FIG. 2). A cover 15 is connected with the electrode holding member 11 to cover the reference electrode 30 and the sensitive electrode 40. The cover 15 is provided with a communication hole 15a through which the oil 4 passes inside and outside the cover 15.

The reference electrode 30 and the sensitive electrode 40 constitute a pair of electrodes (hereinafter referred to as an electrode pair) 20 for detecting acidity or basicity of oil by measuring a difference in potential changed in response to the acidity or basicity of the oil 4.

The reference electrode 30 and the sensitive electrode 40, as shown in FIG. 2, are formed, for example, in a substantially cylindrical shape using a plate-like member. The reference electrode 30 and the sensitive electrode 40 are disposed outside and inside in a double form substantially on concentric circles. The reference electrode 30 and the sensitive electrode 40 are located in the double form, but not limited thereto. The reference electrode 30 and the sensitive electrode 40 may be disposed alternately in a multiple form. Alternatively, the plate-like reference electrode 30 and the plate-like sensitive electrode 40 may be disposed in parallel to each other. It should be noted that in the following embodiments, for simplifying the drawing to be made, the plate-like reference electrode 30 and sensitive electrode 40 shown in FIG. 1 are disposed in parallel to each other as described in the following description.

As shown in FIG. 1, the reference electrode 30 is made of a combination of a metallic salt 32 and a metal 31 which is a basis of the salt 32. More specifically, the reference electrode 30 is formed in an electrode structure including an electrode substrate of the metal 31, and the metallic salt (hereinafter referred to as a hardly soluble salt) which is formed on the substrate (a surface or a surface layer of the substrate in more detail), and which is based on the metal 31 and hardly soluble in water.

In the present embodiment, the electrode structure includes the combination of the hardly soluble salt 32, for example, zinc phosphate [Zn₃(PO₄)₂], and the metal 31 which is the basis of the salt 32, for example, zinc (Zn).

Although the hardly soluble salt 32 is made of zinc phosphate [Zn₃(PO₄)₂] in the embodiment, the hardly soluble salt 32 is not limited thereto. The hardly soluble salt 32 may be any one of iron phosphate [FePO₄], palladium bromide [PdBr₂], silver chloride [AgCl], silver bromide [AgBr], silver iodide [AgI], copper iodide [CuI], and silver sulfide [AgS].

These metallic salt can be made relatively easily by combining the zinc phosphate [Zn₃(PO₄)₂], or iron phosphate [FePO₄], or palladium bromide [PdBr₂], or any one of silver chloride [AgCl], silver bromide [AgBr], silver iodide [AgI], and silver sulfide [AgS], or copper iodide [CuI] with the metal of zinc (Zn), iron (Fe), palladium (Pd), silver (Ag), or copper (Cu), respectively. In the embodiment, the metal 31, which is the basis of the metallic salt 32, may preferably be relatively high purity zinc (Zn) metal which is 99.9% or more pure. This can surely form only the metallic salt 32 on the electrode substrate, that is, on the surface of the metal 31.

As shown in FIG. 1, the sensitive electrode 40 is made of metal material. As this metal material, stainless material (SUS) is used. The stainless material (SUS) has its surface gradually oxidized to form an oxide film during a manufacturing process. Although in the embodiment, the SUS 304 is used as an electrode material for the sensitive electrode 40, any other known material generally called stainless material may be used as the electrode material. For example, any other electrode material that can form a stable metallic oxide, namely, the so-called passive state on the surface of the sensitive electrode 40 may be used.

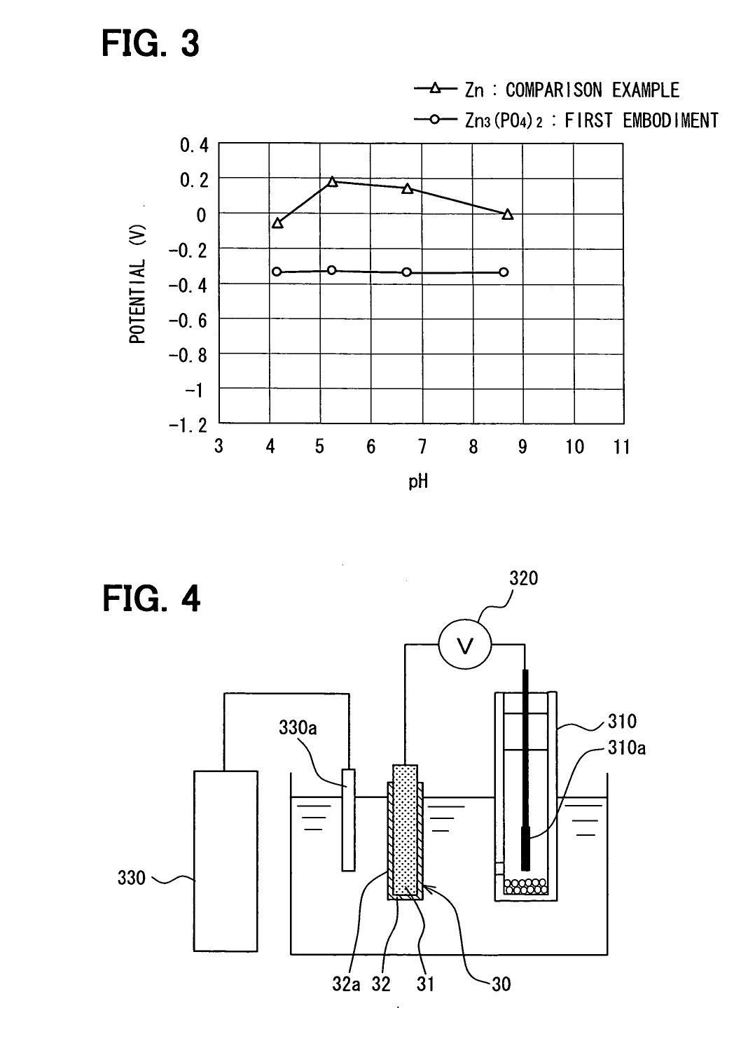

Now, the potential characteristic of the reference electrode 30 with the above-mentioned structure will be described with reference to FIGS. 3, 4, and 5. In FIG. 3, a lateral axis indicates a pH, and a longitudinal axis indicates a potential V of the reference electrode 30. Also as shown in FIG. 3, the potential characteristic of the reference electrode represented by reference character ◯ represents a potential of the reference electrode of the embodiment with respect to a change in the pH.

The potential characteristic of a reference electrode of a comparative example which is composed of a single metal of zinc (Zn) is illustrated by a reference character Δ for comparison with the embodiment of the invention.

As shown in FIG. 4, the potential of the reference electrode 30 is measured using a pH measuring device 330 with a glass electrode 330a, and a test device including a commonly available reference electrode 310. A solution to be tested is a dummy oil whose pH is adjusted by adding hydrochloric acid into 2-propanol.

For the pH measured by the glass electrode 330a, the potential of the reference electrode 30 of the embodiment at that time is measured, compared with that of the commonly available reference electrode 310 of the comparative example (more specifically, a known electrode obtained by immersing a silver and silver chloride electrode 310a in a solution inside a casing), whereby the potential characteristic shown in FIG. 3 is obtained.

As shown in FIG. 3, the reference electrode made of a single metal, such as zinc (Zn) in the comparative example is varied by about −0.1 to 0.2 V with respect to the change in pH, and does not exhibit the linearity. In contrast, at the reference electrode 30 which is composed of the combination of metal, e.g. zinc (Zn), and the hard-soluble salt, e.g. zinc phosphate [Zn₃(PO₄)₂] of the embodiment, a substantially constant voltage of about 0.3 V can be obtained, not depending on the pH.

This characteristic or property is shown only in a non-aqueous solution (dummy oil) whose water content is extremely small, unlike an aqueous solution. Also, when the solution to be measured is an oil 4 (more specifically, an engine oil), the water content in the solution is so small that the same potential characteristic as that represented by the reference character ◯ in FIG. 3 is obtained.

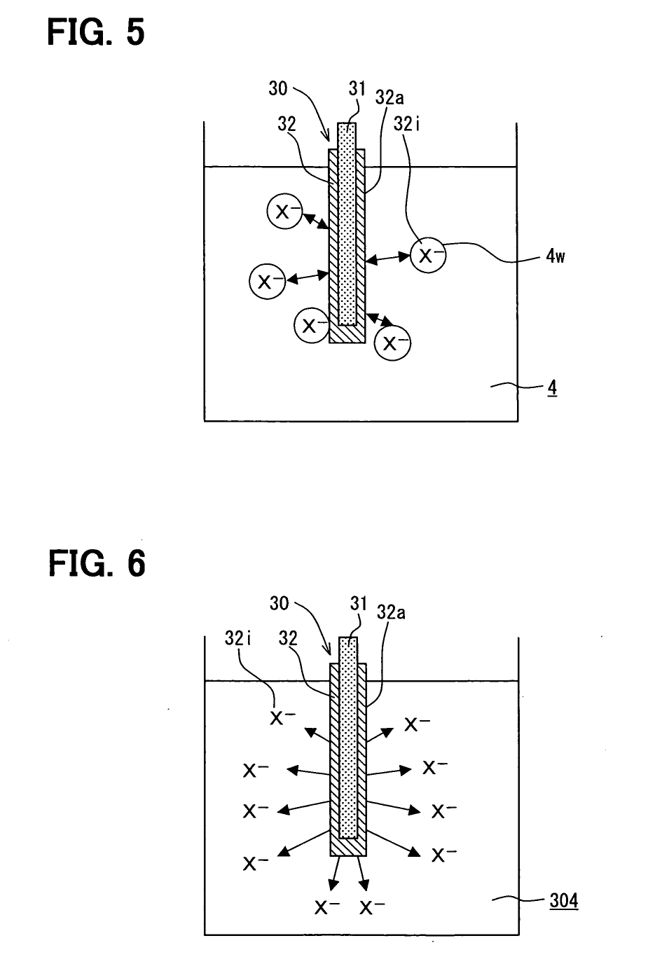

A mechanism for potential output at the reference electrode 30 of the embodiment depending on variations in solutions to be measured will be described below with reference to FIGS. 5 and 6. FIG. 5 shows a case in which the oil 4 (non-aqueous solution) is used as the solution to be measured, and FIG. 6 shows a case in which the aqueous solution 304 is used as the solution. The oil 4 contains a small amount of water 4w, which is represented by a circle in FIG. 5.

Reference character x in FIGS. 5 and 6 denotes an anion eluted from a surface 32a of the hardly soluble salt 32 (zinc phosphate [Zn₃(PO₄)₂]) .

The reference electrode 30 is composed of a combination of the metal 31 (zinc (Zn)) and the hardly soluble salt 32 (zinc phosphate [Zn₃(PO₄)₂]). On the surface of the metal 31, is formed the hardly soluble salt 32, whose anion X is an inorganic ion.

The potential of the reference electrode 30 is output according to the concentration of ions in each of the solutions 4 and 304. In general, since the anion x, which is the inorganic ion, is hardly soluble in the oil 4 itself, which is a non-aqueous solution, the anion is dissolved in the water 4w which exists in a small amount (see FIG. 4).

The hardly soluble salt 32 is not dissolved in the solutions 4, 304 at all, but is not very soluble in them. When a small amount of water 4w is contained in the non-aqueous solution, such as oil 4, the concentration of anions x in the water 4w reaches substantially saturation or dissolution equilibrium.

Thus, fluctuations in the concentration of hydrogen ions in the non-aqueous solution, that is, fluctuations in the concentration of anions x are small even when the acidity of the oil 4 is changed, so that the reference electrode 30 in the oil 4 has a substantially constant potential output with respect to the change in pH.

In contrast, in the comparative example of the reference electrode 30 in the aqueous solution 304 (see FIG. 6), it is obvious that the anion x is a component of the aqueous solution 304. In the aqueous solution 304, no anions x exist, or the concentration of the anions x is not adjusted. In such a condition, the anions x are gradually eluted from the surface 32a of the hardly soluble salt 32 over time.

Thus, the potential output (not shown) of the reference electrode 30 in the aqueous solution 304 is output and varied by a relatively large amount for a relatively long elapsed time. This potential output in the comparative example is very different from that of the reference electrode 30 in the oil 4 according to the embodiment.

Next, the advantages of the embodiment will be described below in detail. In the embodiment, in order to keep the output potential substantially constant with respect to the pH of the oil 4 which is changed according to the acidity or basicity of the oil 4 to be measured, the reference electrode 30 is constructed of an electrode structure having the metal salt 32 formed on an electrode substrate of the metal 31, the metal salt containing the metal 31 and being hardly soluble in water.

Thus, all anions x of the metal salt which is hardly soluble in water, that is, of the so-called hardly soluble salt 32 are not insoluble in the solutions 4, 304, but are not very soluble therein. When a relatively small amount of the water 4w is contained in the oil 4 to be measured, the concentration of anions x in the water 4wcan reach substantially saturation or dissolution equilibrium.

Furthermore, because the hardly soluble salt 32 based on the metal 31 is previously formed on the surface of the metal 31 of the reference electrode 30, the hardly soluble salt 32 is not generated, and its amount is not increased in the measurement step, unlike the case of the metallic oxide. On the other hand, the elution of the anions x from the hardly soluble salt 32 is hardly caused because the concentration of the anions substantially reaches the saturation or dissolution equilibrium. This can stabilize the condition of the surface 32a of the reference electrode 30.

Accordingly, the condition of the surface 32a of the electrode in the electrode structure 31 and 32 is stabilized such that a stable constant potential is obtained with respect to the change in pH of the oil 4 to be measured.

In the embodiment, the potential of the reference electrode 30 is output according to the concentration of the anions x eluted from the surface 32a of the hardly soluble salt 32, and the concentration of the anions in the water 4w contained in the oil 4 substantially reaches the saturation or dissolution equilibrium. This can obtain the stable constant potential at the reference electrode with respect to the change in pH of the oil 4.

In the embodiment, since the hardly soluble salt 32 is made of zinc phosphate [Zn₃(PO₄)₂], the reference electrode 30 is provided so as to stabilize the condition of the surface 32a of the electrode of each of the electrode structures 31, 32 and to obtain its stable constant potential with respect to the change in pH of the oil 4 to be measured.

Such a hardly soluble salt 32 can be made relatively easily by combining the zinc phosphate [Zn₃(PO₄)₂] with the metal 31, for example, zinc [Zn]. For example, the metal 31 included in the electrode substrate is preferably 99.9% or more pure. This can surely form only the hardly soluble salt 32 on the electrode substrate, that is, on the surface of the metal 31.

Furthermore, in the embodiment, the reference electrode 30 uses the oil 4 as the solution to be measured. This kind of oil 4 is a non-aqueous solution, in which water 4w exists in a very small amount. With this arrangement, the relatively gradual elution of the anions x from the hardly soluble salt 32 causes the concentration of the anions x in the water 4w to readily reach the saturation or dissolution equilibrium. Thus, the constant potential output of the reference electrode 30 in the oil 4 can be obtained responsively in a reproducible manner with respect to the change in pH of the oil 4.

Moreover, in the embodiment, an engine oil is used as the oil 4. The working temperature range of the engine oil is generally in a range of relatively higher temperatures than the room temperature (for example, about 80 to 150° C.).

In contrast, since the reference electrode 30 of the embodiment is an inorganic individual member made of the metal 31 and the hardly soluble salt 32, the reference electrode 30 has high reliability of heat resistance and the like as compared with a reference electrode containing an organic material, such as an organic film.

In the embodiment, the sensitive electrode 40 used in combination with the above-mentioned reference electrode 30 to constitute the pair of electrodes 20 may preferably be a metal electrode made of, for example, stainless material, and having its surface covered with a metallic oxide. This can form the passive state on the surface of the sensitive electrode with the metallic oxide.

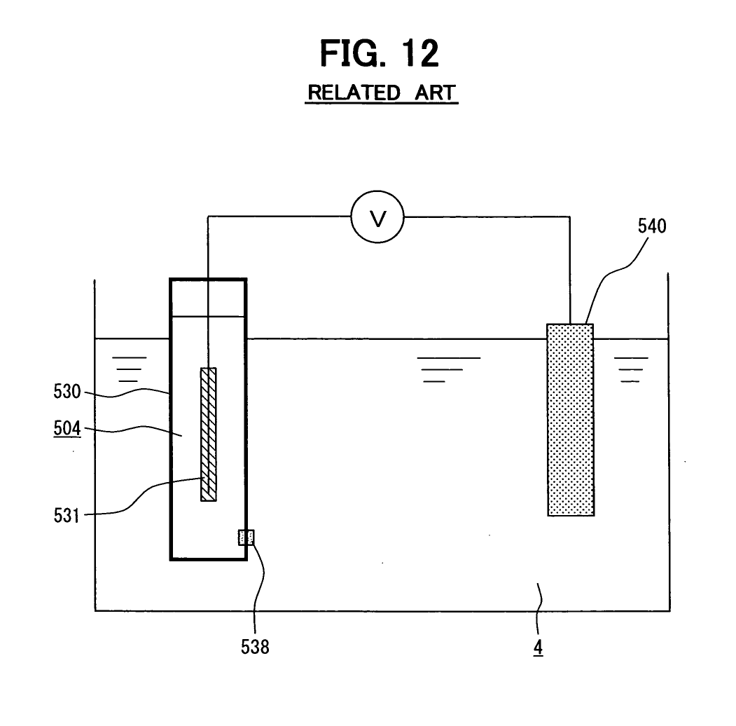

A comparison method for measuring a potential with respect to a changed pH of the non-aqueous solution (oil) 4 is carried out by a device shown in FIG. 12. In FIG. 12, a reference electrode 531 made of silver and silver chloride is immersed into an inside solution 504 (aqueous solution) within a casing 530. In this state, the electrode is brought into contact with the non-aqueous solution (oil) 4 to be measured via a liquid junction 538. The liquid junction 538 is made of a filter, a glass sleeve, or the like, and is to prevent the leak and entering of the liquid, while keeping ion conduction from a response electrode 540 of the solution (oil) 4 to be measured. The reference electrode 531 intends to keep its potential constant in the inside solution (aqueous solution) 504.

Even in the reference electrode 531, the silver chloride is also the hardly soluble salt. However, the inside solution 504 used is an aqueous solution, such as a potassium chloride (KCl) solution. This case shown in FIG. 12 differs from the first embodiment in that the silver chloride of the reference electrode 531 exists in the solution 504 containing the potassium chloride (KCl) or the like.

Since the reference electrode 30 of the first embodiment is directly immersed into the solution (oil) 4 to be measured, the liquid junction 538 shown in FIG. 12 is unnecessary, and the structure of the reference electrode 30 can be simplified.

Moreover, when the engine oil is used as the oil 4, the liquid junction 538 shown in FIG. 12 may be clogged with contamination of the engine oil, causing the potential in the liquid junction 538. In contrast, the reference electrode 30 of the first embodiment can stably obtain the substantially constant potential with respect to the change in pH of the non-aqueous liquid (oil) 4 in the reproducible manner because the liquid junction 538 is not needed.

(Second Embodiment)

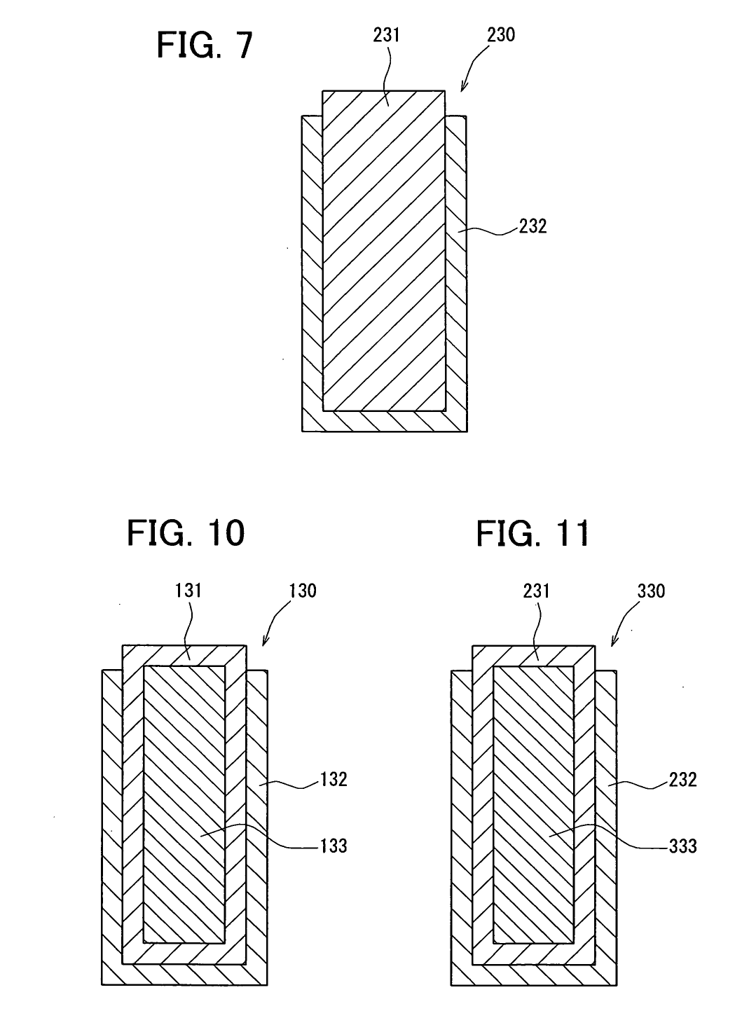

The second embodiment will be described in detail with reference to FIGS. 7-9. In this embodiment, the same reference numbers will be given throughout the drawings to refer to the same or like parts as those in the first embodiment, and thus the description thereof will be omitted hereinafter.

In the first embodiment described above, in order to keep the output potential of the reference electrode substantially constant with reference to the pH change according to the acidity or basicity of the oil 4, the combination of zinc [Zn] and zinc phosphate [Zn₃(PO₄)₂] is used as the combination of the metal 31 and the hardly soluble salt 32 of the reference electrode 30, respectively.

In contrast, in the second embodiment shown in FIG. 7, the combination of silver [Ag] and silver chloride [AgCl] is used as the combination of a metal 231 and a hardly soluble salt 232 of a reference electrode 230, respectively.

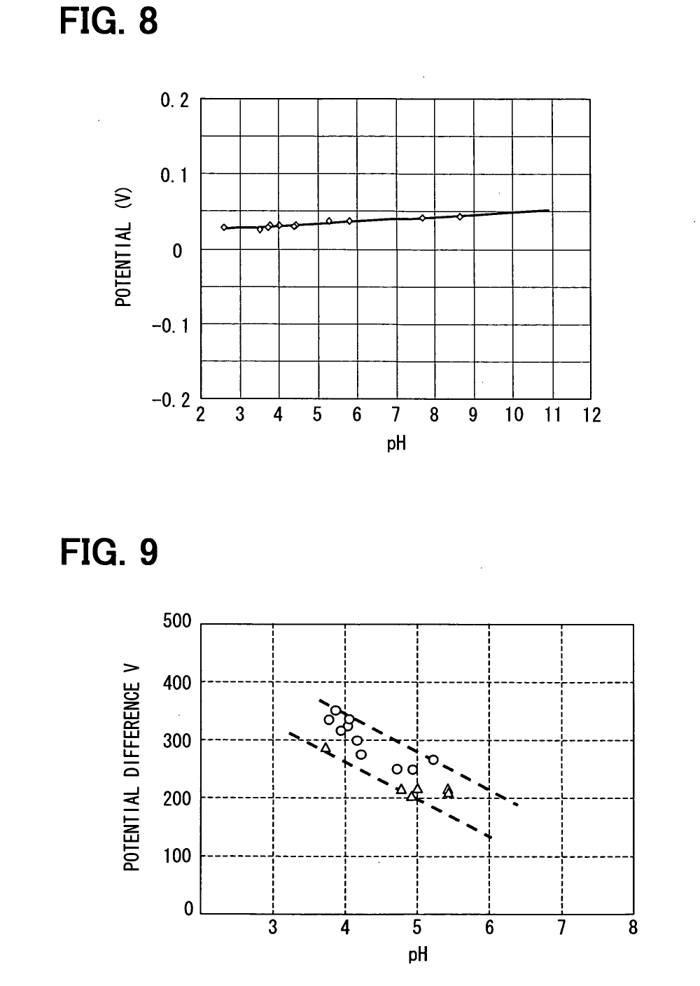

FIG. 7 schematically shows a sectional view of the reference electrode for detecting the acidity or basicity of the oil according to the embodiment. FIG. 8 is a graph showing a potential characteristic of the reference electrode of the second embodiment, while showing a relationship between an electric potential of the reference electrode and a pH. FIG. 9 is a graph showing a potential difference characteristic of a pair of electrodes using the reference electrode for detecting acidity or basicity of oil of the second embodiment, while showing a relationship between a pH and a difference in potential between the reference electrode and the sensitive electrode.

In FIG. 9, the potential characteristics by broken lines is obtained by making linear approximation of and plotting data on measured values of differences in potential V, while changing a pH of the test solution in measuring the difference in potential. In FIG. 9, reference character ◯ denotes a result of the use of the dummy oil as described in the first embodiment, and reference character Δ denotes a result of the use of a sample of deteriorated oil collected through market researches or the like for verification.

As shown in FIG. 7, the reference electrode 230 is constructed of an electrode structure which includes an electrode substrate made of the metal 231, for example, silver (Ag), and the hardly soluble salt 232 formed on the substrate, and made of, for example, silver chloride [AgCl] based on the silver (Ag).

As shown in FIG. 8, the potential characteristic of the reference electrode 230 in the oil (4) is increased linearly from 0.3 V to 0.45 V in a range of pH of 2.6 to 8.6. The rate of the increase is very small. Therefore, the potential output of the reference electrode 230 with the silver chloride [AgCl] being immersed in the oil (4) hardly depends on the pH, and is kept substantially constant.

FIG. 9 shows that the potential difference characteristics of the pair of electrodes 20 consisting of the reference electrode 230 and the sensitive electrode 40 fluctuate within a range represented by the broken line, but the average inclination of the change in the potential difference is −60 mV/pH with respect to a decrease in pH due to the deterioration of the oil 4, which satisfies the Nernst equation. That is, it is understood that the proton response of the stainless material (SUS) serving as the material for the sensitive electrode 40 exhibits the Nernst effect, and the theoretically correct output of the electrode pair 20 is obtained.

This result shows that the potential difference characteristics of the pair of electrodes 20 consisting of the combination of the reference electrode 230 of the embodiment and the sensitive electrode 40 is more efficient for repeated use. Such an arrangement can obtain the advantages described in the first embodiment.

(Other Embodiments)

Although the present invention has been fully described in connection with the preferred embodiments thereof with reference to the accompanying drawings, it is to be noted that various changes and modifications will become apparent to those skilled in the art.

For example, in the above-mentioned embodiments, the solution to be measured into which the reference electrode 30, 230 is immersed is an engine oil (oil) 4, the invention is not limited thereto. The solution to be measured may be any other non-aqueous solution in which a very small amount of water exists.

In the first embodiment described above, the combination of the metal 31 and the hardly soluble salt 32 of the reference electrode 30 is the combination of the zinc (Zn) and the zinc phosphate [Zn₃(PO₄)₂] such that the output potential of the reference electrode is kept substantially constant with respect to a pH which is changed according to acidity and basicity of the oil 4. The combination of the metal and the hardly soluble salt 32 may not be limited the zinc (Zn) and the zinc phosphate [Zn₃(PO₄)₂], but any one of combinations including iron (Fe) and iron phosphate [FePO₄], palladium (Pd) and palladium bromide [PdBr₂], silver (Ag) and any one of silver chloride [AgCl], silver bromide [AgBr], silver iodide [AgI], and silver sulfide [AgS], and copper (Cu) and copper iodide [CuI].

In the combination described above, the potential output of the reference electrode 30 is according to the concentration of the anions x eluted from the hardly soluble salt, and the concentration of the anions reaches substantially saturation or dissolution equilibrium in the water 4w contained in the oil 4. This can obtain the stable constant potential of the reference electrode with respect to the change in pH of the oil 4.

In the first embodiment as described above, the reference electrode 30 is constructed of the electrode structure including the hardly soluble salt 32 based on the metal 31, and formed on the electrode substrate of the metal 31. In general, when the metallic structure is composed of the hardly soluble salt 32 and the metal 31 which is basis of the salt 32, in the form of a thin plate, the strength of the electrode structure may not be ensured sufficiently. In another embodiment, as shown in FIG. 10, a reference electrode 130 may be constructed of a film-like electrode substrate structure including a substrate 133, and film parts constituting electrode structures 131 and 132 and formed on the surface of the substrate 133.

In such an embodiment, a substrate 133 made of stainless material (SUS), for example, is used, and thin film-like or thin plate-like parts constituting metallic structures 131 and 132 are formed on the surface of the substrate 133, for example, by vapor deposition. Therefore, the entire substrate 133 and metallic structures 131 and 132 can improve the strength of the electrode.

Although the substrate 133 is made of stainless material (SUS), the invention is not limited. The substrate 133 may be made of any one of platinum (Pt), and palladium (Pd).

In the second embodiment as described above, the reference electrode 230 is constructed of the electrode structure in which the hardly soluble salt 232 of the silver chloride [AgCl] based on silver (Ag) 31 is formed on the electrode substrate made of the metal 231 of silver [Ag], but the invention is not limited thereto. Like a reference electrode 330 of another embodiment shown in FIG. 11, the thin plate-like or thin film-like parts constituting the metallic structures 231 and 232 may be formed on the surface of the substrate 333.

It should be noted that in a method for manufacturing the reference electrode, when the metal 31, 231 is zinc (Zn) or iron (Fe) in the combination of the metal 31, 231, and the hardly soluble salt 32, 232, the hardly soluble salt 32, 232 is formed on the plate or wire rod made of the metal 31, 231 by a forming process, such as a chemical conversion process, a printing process, or the like.

In the case where the metal 31, 231 is silver (Ag), palladium (Pd), or copper (Cu), the hardly soluble salt 32, 23 is formed on the plate or wire rod made of the metal 31 by another forming process, such as an anode electrolysis process, or a printing process.

When the electrode structure 133, 333 is formed as the film part on the surface of the reference electrode 130, 330, the following example will be proposed. The metal 31, 231, which may be any one of zinc (Zn), silver (Ag), iron (Fe), palladium (Pd) and copper (Cu), may be formed on the substrate, which may be made of any one of platinum (Pt), palladium (Pd), and stainless material (SUS) by a manufacturing method, including plating, spattering, vapor deposition, and the like. Then, by the above-mentioned method, the hardly soluble salt 32, 232 may be further formed on the metal 31, 231.

Although in the embodiments as described above, the hardly soluble salt 32, 132, 232 is formed to cover the surface or surface layer of the metal 31, 131, 231, the hardly soluble salt 32 does not necessarily cover at least the entire part to be immersed in the solution to be measured, and the metal 31, 131, 231 may be partially exposed.

Such changes and modifications are to be understood as being within the scope of the present invention as defined by the appended claims.

What is claimed is:

1. A reference electrode for detecting acidity or basicity of an oil with a sensitive electrode changed in response to the acidity or basicity of the oil, the reference electrode and the sensitive electrode being used as a pair of electrodes for detecting a difference between an electric potential of the sensitive electrode and an electric potential of the reference electrode, the reference electrode having a substantially constant output potential with respect to a pH which is changed according to the acidity or basicity of the oil, the reference electrode comprising:
an electrode substrate made of a metal; and
a metal salt provided on the electrode substrate, wherein the metal salt contains the metal and is hardly soluble in water.

2. The reference electrode according to claim 1, wherein the metal salt is selected from a group consisting of zinc phosphate [Zn₃(PO₄)₂], iron phosphate [FePO₄], palladium bromide [PdBr₂], silver chloride [AgCl], silver bromide [AgBr], silver iodide [AgI], copper iodide [CuI], and silver sulfide [AgS].

3. The reference electrode according to claim 1, wherein the sensitive electrode is a metallic electrode having a surface layer covered with a metallic oxide.

4. The reference electrode according to claim 1, wherein the electrode substrate and the metal salt are provided to form a film electrode including a substrate part and a film part formed on the substrate part.

5. The reference electrode according to claim 1, wherein the metal constituting the electrode substrate is 99.9% or more pure.

6. The reference electrode according to claim 1, wherein water content of the oil is extremely low.

7. The reference electrode according to claim 1, wherein the oil is a hydraulic oil for use in an internal combustion engine.

8. A detector for detecting acidity or basicity of an oil, the detector comprising:
a reference electrode; and
a sensitive electrode changed in response to the acidity or basicity of the oil, wherein:
the reference electrode and the sensitive electrode are used as a pair of electrodes for detecting a difference between an electric potential of the sensitive electrode and an electric potential of the reference electrode;
the reference electrode includes an electrode substrate made of a metal, and a metal salt provided on the electrode substrate, the metal salt containing the metal and being hardly soluble in water; and
the reference electrode has a substantially constant output potential with respect to a pH which is changed according to the acidity or basicity of the oil.

9. The detector according to claim 8, wherein the metal salt for the reference electrode is selected from a group consisting of zinc phosphate [Zn₃(PO₄)₂], iron phosphate [FePO₄], palladium bromide [PdBr₂], silver chloride [AgCl], silver bromide [AgBr], silver iodide [AgI], copper iodide [CuI], and silver sulfide [AgS].

10. The detector according to claim 8, wherein the sensitive electrode is a metallic electrode having a surface layer covered with a metallic oxide.

11. The detector according to claim 8, wherein the reference electrode is a film electrode including a substrate part and a film part formed on the substrate part.

12. The detector according to claim 8, wherein the metal constituting the electrode substrate of the reference electrode is 99.9% or more pure.

13. The detector according to claim 8, wherein water content of the oil is extremely low.

14. The detector according to claim 8, wherein the oil is a hydraulic oil for use in an internal combustion engine.

15. The detector according to claim 8, wherein at least a part of the reference electrode and the sensitive electrode is embedded in the oil.

16. The detector according to claim 11, wherein the film part is constructed with the electrode substrate and the metal salt in the reference electrode.
